(19) United States
(12) Patent Application Publication
(10) Pub. No.: US 2024/0314692 A1
(43) Pub. Date: Sep. 19, 2024

(54) COMMUNICATION APPARATUSES AND COMMUNICATION METHODS FOR OPERATING IN A POWER SAVING STATE

(71) Applicant: Panasonic Intellectual Property Corporation of America, Torrance, CA (US)

(72) Inventors: Yang KANG, Singapore (SG); Hidetoshi SUZUKI, Kanagawa (JP); Hong Cheng, Michael SIM, Singapore (SG); Xuan Tuong TRAN, Singapore (SG)

(21) Appl. No.: 18/260,893

(22) PCT Filed: Nov. 15, 2021
(86) PCT No.: PCT/SG2021/050699

§ 371 Date: Jul. 10, 2023

(30) Foreign Application Priority Data
Jan. 18, 2021 (SG) 10202100539Y
Mar. 29, 2021 (SG) 10202103195T

(51) Int. Cl. H04W 52/02; H04W 92/18

(52) U.S. Cl. CPC H04W 52/0235; H04W 92/18

(57) ABSTRACT

The present disclosure provides communication apparatuses and communication methods for operating in a power saving state. The communication apparatuses comprising circuitry, which in operation, determines one of a plurality of power saving states to operate in; and a transceiver, which in operation, transmit and/or receive at least one type of sidelink signals in response to determining the one of the plurality of power saving states.

### TECHNICAL FIELD

The following disclosure relates to communication apparatuses and communication methods for operating in a power saving state, and more particularly for a sidelink user equipment (UE).

### BACKGROUND

Vehicle-to-everything (V2X) communication allows vehicles to interact with public roads and other road users, and is thus considered a critical factor in making autonomous vehicles a reality.

To accelerate this process, 5G new radio access technology (NR) based V2X communications (interchangeably referred to as NR V2X communications) is being discussed by the 3rd Generation Partnership Project (3GPP) to identify technical solutions for advanced V2X services, through which vehicles (i.e. interchangeably referred to as communication apparatuses or user equipments (UEs) that support V2X applications) can exchange their own status information through sidelink (SL) with other nearby vehicles, infrastructure nodes and/or pedestrians. The status information includes information on position, speed, heading, etc.

According to identification in Release 17 (Rel-17) V2X Work Item Description (WID) (RP-202846), power saving enables UEs with battery constraint to perform sidelink operations in a power efficient manner. Rel-16 NR sidelink is designed based on the assumption of “always-on” when UE operates sidelink, e.g., only focusing on UEs installed in vehicles with sufficient battery capacity. Solution for power saving in Rel-17 are required for vulnerable road users (VRUs) in V2X use cases and for UEs in public safety and commercial use cases where power consumption in the UEs needs to be minimized.

Also, in RAN1 #103-e meeting, two UE reception type (i.e. with or without reception capability) has been concluded for evaluation and power saving features in Rel-17.

In particular, it is not clear how a SL UE should become power saving, and how a SL UE balances its power saving with performance requirements.

Hence, there is a need to address one or more of the above challenges and develop new communication apparatuses and communication methods for operating in a power saving state. Furthermore, other desirable features and characteristics will become apparent from the subsequent detailed description and the appended claims, taken in conjunction with the accompanying drawings and this background of the disclosure.

### SUMMARY

One non-limiting and exemplary embodiment facilitates providing communication apparatuses and methods for utilisation of SL-RSRP in V2X resource sensing & selection.

In a first aspect, the present disclosure provides a communication apparatus comprising: circuitry, which in operation, determines one of a plurality of power saving states to operate in; and a transceiver, which in operation, transmit and/or receive at least one type of sidelink signals in response to determining the one of the plurality of power saving states.

In a second aspect, the present disclosure provides a communication method comprising: determining one of a plurality of power saving states to operate in; and transmitting and/or receiving at least one type of sidelink signals in response to determining the one of the plurality of power saving states.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

Embodiments of the disclosure will be better understood and readily apparent to one of ordinary skilled in the art from the following written description, by way of example only, and in conjunction with the drawings, in which:

FIG. 1 shows an exemplary 3GPP NR-RAN architecture.

FIG. 2 depicts a schematic drawing which shows functional split between NG-RAN and 5GC.

FIG. 3 depicts a sequence diagram for radio resource control (RRC) connection setup/reconfiguration procedures.

FIG. 4 depicts a schematic drawing showing usage scenarios of Enhanced mobile broadband (eMBB), Massive Machine Type Communications (mMTC) and Ultra Reliable and Low Latency Communications (URLLC).

FIG. 5 shows a block diagram showing an exemplary 5G system architecture for V2X communication in a non-roaming scenario.

FIG. 6 shows a schematic example of communication apparatus in accordance with various embodiments. The communication apparatus may be implemented as a UE or a gNB/base station and configured for vulnerable road users to transmit a first signal at a periodic transmission time interval in accordance with various embodiments of the present disclosure.

FIG. 7 shows a flow diagram illustrating a communication method for vulnerable road users to transmit a first signal at a periodic transmission time interval in accordance with various embodiments of the present disclosure.

FIG. 8 depicts a flow chart illustrating four power saving state configurations for SL signals reception according to an embodiment of the present disclosure.

FIGS. 9-11 depict three flow charts illustrating use of an indication signal to configure a UE to operate in one of a plurality of power saving states according to various embodiment of the present disclosure respectively.

FIG. 12 depicts a flow chart illustrating a process to switch from a current one power saving state to a preferred power saving state according to an embodiment of the present disclosure.

FIG. 13 depicts a flow chart illustrating a process to indicate a switch from a power saving state currently operated by a communication apparatus to another power saving state by another communication apparatus according an embodiment of the present disclosure.

FIG. 14 depict a flow chart illustrating a process to operate in a default power saving state according to an embodiment of the present disclosure.

Skilled artisans will appreciate that elements in the figures are illustrated for simplicity and clarity and have not necessarily been depicted to scale. For example, the dimensions of some of the elements in the illustrations, block diagrams or flowcharts may be exaggerated in respect to other elements to help to improve understanding of the present embodiments.

### DETAILED DESCRIPTION

Some embodiments of the present disclosure will be described, by way of example only, with reference to the drawings. Like reference numerals and characters in the drawings refer to like elements or equivalents.

3GPP has been working at the next release for the 5th generation cellular technology, simply called 5G, including the development of a new radio access technology (NR) operating in frequencies ranging up to 100 GHz. The first version of the 5G standard was completed at the end of 2017, which allows proceeding to 5G NR standard-compliant trials and commercial deployments of smartphones. The second version of the 5G standard was completed in June 2020, which further expand the reach of 5G to new services, spectrum and deployment such as unlicensed spectrum (NR-U), non-public network (NPN), time sensitive networking (TSN) and cellular-V2X.

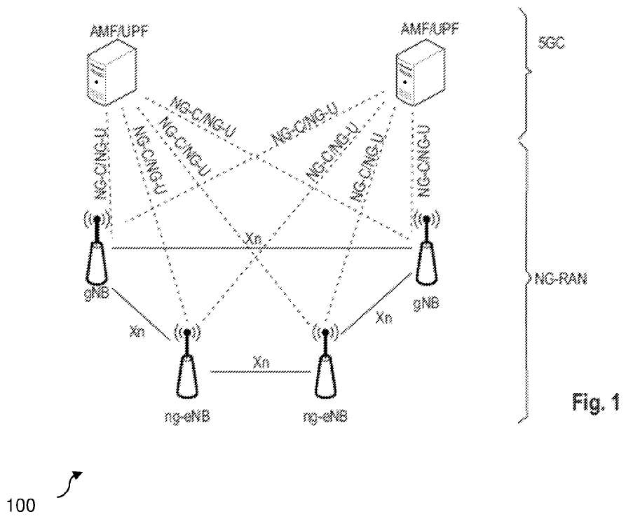

Among other things, the overall system architecture assumes an NG-RAN (Next Generation-Radio Access Network) that comprises gNBs, providing the NG-radio access user plane (SDAP/PDCP/RLC/MAC/PHY) and control plane (RRC) protocol terminations towards the UE. The gNBs are interconnected with each other by means of the Xn interface. The gNBs are also connected by means of the Next Generation (NG) interface to the NGC (Next Generation Core), more specifically to the AMF (Access and Mobility Management Function) (e.g. a particular core entity performing the AMF) by means of the NG-C interface and to the UPF (User Plane Function) (e.g. a particular core entity performing the UPF) by means of the NG-U interface. The NG-RAN architecture is illustrated in FIG. 1 (see e.g. 3GPP TS 38.300 v16.3.0).

The user plane protocol stack for NR (see e.g. 3GPP TS 38.300, section 4.4.1) comprises the PDCP (Packet Data Convergence Protocol, see section 6.4 of TS 38.300), RLC (Radio Link Control, see section 6.3 of TS 38.300) and MAC (Medium Access Control, see section 6.2 of TS 38.300) sublayers, which are terminated in the gNB on the network side. Additionally, a new access stratum (AS) sublayer (SDAP, Service Data Adaptation Protocol) is introduced above PDCP (see e.g. sub-clause 6.5 of 3GPP TS 38.300). A control plane protocol stack is also defined for NR (see for instance TS 38.300, section 4.4.2). An overview of the Layer 2 functions is given in sub-clause 6 of TS 38.300. The functions of the PDCP, RLC and MAC sublayers are listed respectively in sections 6.4, 6.3, and 6.2 of TS 38.300. The functions of the RRC layer are listed in sub-clause 7 of TS 38.300.

For instance, the Medium-Access-Control layer handles logical-channel multiplexing, and scheduling and scheduling-related functions, including handling of different numerologies.

The physical layer (PHY) is for example responsible for coding, PHY hybrid automatic repeat request (HARQ) processing, modulation, multi-antenna processing, and mapping of the signal to the appropriate physical time-frequency resources. It also handles mapping of transport channels to physical channels. The physical layer provides services to the MAC layer in the form of transport channels. A physical channel corresponds to the set of time-frequency resources used for transmission of a particular transport channel, and each transport channel is mapped to a corresponding physical channel. For instance, the physical channels are PRACH (Physical Random Access Channel), PUSCH (Physical Uplink Shared Channel) and PUCCH (Physical Uplink Control Channel) for uplink, PDSCH (Physical Downlink Shared Channel), PDCCH (Physical Downlink Control Channel) and PBCH (Physical Broadcast Channel) for downlink, and PSSCH (Physical Sidelink Shared Channel), PSCCH (Physical Sidelink Control Channel) and Physical Sidelink Feedback Channel (PSFCH) for sidelink (SL).

SL supports UE-to-UE direct communication using the SL resource allocation modes, physical layer signals/channels, and physical layer procedures. Two SL resource allocation mode are supported: (a) mode 1, where the SL resource allocation is provided by the network; and (b) mode 2, where UE decides SL transmission resource in the resource pool(s).

PSCCH indicates resource and other transmission parameters used by a UE for PSSCH. PSCCH transmission is associated with a demodulation reference signal (DM-RS). PSSCH transmits the transport blocks (TBs) of data themselves, and control information for HARQ procedure and channel state information (CSI) feedback triggers, etc. At least 6 Orthogonal Frequency Division Multiplex (OFDM) symbols within a slot are used for PSSCH transmission. PSSCH transmission is associated with a DM-RS and may be associated with a phase-tracking reference signal (PT-RS).

PSFCH carries HARQ feedback over the SL from a UE which is an intended recipient of a PSSCH transmission to the UE which performed the transmission. PSFCH sequence is transmitted in one PRB repeated over two OFDM symbols near the end of the SL resource in a slot.

The SL synchronization signal consists of SL primary and SL secondary synchronization signals (S-PSS, S-SSS), each occupying 2 symbols and 127 subcarriers. Physical Sidelink Broadcast Channel (PSBCH) occupies 9 and 5 symbols for normal and extended cyclic prefix cases respectively, including the associated demodulation reference signal (DM-RS).

Regarding physical layer procedure for HARQ feedback for sidelink, SL HARQ feedback uses PSFCH and can be operated in one of two options. In one option, which can be configured for unicast and groupcast, PSFCH transmits either ACK or NACK using a resource dedicated to a single PSFCH transmitting UE. In another option, which can be configured for groupcast, PSFCH transmits NACK, or no PSFCH signal is transmitted, on a resource that can be shared by multiple PSFCH transmitting UEs.

In SL resource allocation mode 1, a UE which received PSFCH can report SL HARQ feedback to gNB via PUCCH or PUSCH.

Regarding physical layer procedure for power control for sidelink, for in-coverage operation, the power spectral density of the SL transmissions can be adjusted based on the pathloss from the gNB; whereas for unicast, the power spectral density of some SL transmissions can be adjusted based on the pathloss between the two communicating UEs.

Regarding physical layer procedure for CSI report, for unicast, channel state information reference signal (CSI-RS) is supported for CSI measurement and reporting in sidelink. A CSI report is carried in a SL MAC CE.

For measurement on the sidelink, the following UE measurement quantities are supported:
PSBCH reference signal received power (PSBCH RSRP);
PSSCH reference signal received power (PSSCH-RSRP);
PSCCH reference signal received power (PSCCH-RSRP);
Sidelink received signal strength indicator (SL RSSI);
Sidelink channel occupancy ratio (SL CR);
Sidelink channel busy ratio (SL CBR).

Use cases/deployment scenarios for NR could include enhanced mobile broadband (eMBB), ultra-reliable low-latency communications (URLLC), massive machine type communication (mMTC), which have diverse requirements in terms of data rates, latency, and coverage. For example, eMBB is expected to support peak data rates (20 Gbps for downlink and 10 Gbps for uplink) and user-experienced data rates in the order of three times what is offered by IMT-Advanced. On the other hand, in case of URLLC, the tighter requirements are put on ultra-low latency (0.5 ms for UL and DL each for user plane latency) and high reliability (1-10⁻⁵ within 1 ms). Finally, mMTC may preferably require high connection density (1,000,000 devices/km² in an urban environment), large coverage in harsh environments, and extremely long-life battery for low cost devices (15 years).

Therefore, the OFDM numerology (e.g. subcarrier spacing, OFDM symbol duration, cyclic prefix (CP) duration, number of symbols per scheduling interval) that is suitable for one use case might not work well for another. For example, low-latency services may preferably require a shorter symbol duration (and thus larger subcarrier spacing) and/or fewer symbols per scheduling interval (aka, TTI) than an mMTC service. Furthermore, deployment scenarios with large channel delay spreads may preferably require a longer CP duration than scenarios with short delay spreads. The subcarrier spacing should be optimized accordingly to retain the similar CP overhead. NR may support more than one value of subcarrier spacing. Correspondingly, subcarrier spacing of 15 kHz, 30 kHz, 60 kHz . . . are being considered at the moment. The symbol duration Tᵤ and the subcarrier spacing Δf are directly related through the formula Δf=1/Tᵤ. In a similar manner as in LTE systems, the term “resource element” can be used to denote a minimum resource unit being composed of one subcarrier for the length of one OFDM/SC-FDMA symbol.

In the new radio system 5G-NR for each numerology and carrier a resource grid of subcarriers and OFDM symbols is defined respectively for uplink and downlink. Each element in the resource grid is called a resource element and is identified based on the frequency index in the frequency domain and the symbol position in the time domain (see 3GPP TS 38.211 v16.3.0).

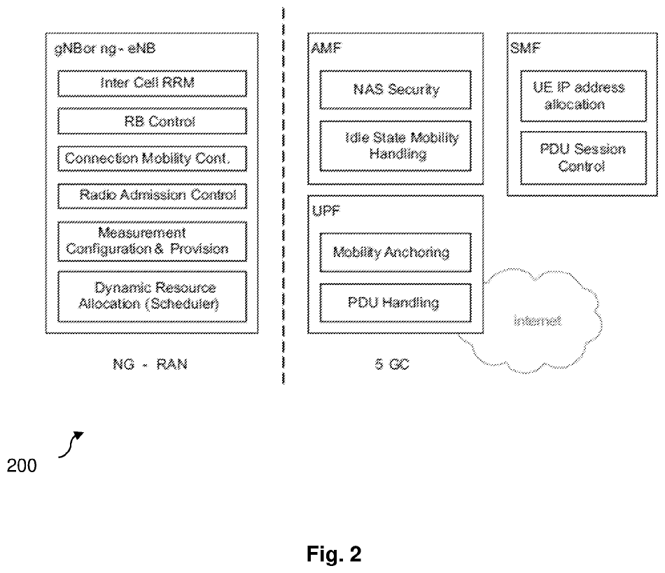

FIG. 2 illustrates functional split between NG-RAN and 5GC. NG-RAN logical node is a gNB or ng-eNB. The 5GC has logical nodes AMF, UPF and SMF.

In particular, the gNB and ng-eNB host the following main functions:
Functions for Radio Resource Management such as Radio Bearer Control, Radio Admission Control, Connection Mobility Control, Dynamic allocation of resources to UEs in both uplink and downlink (scheduling);
IP header compression, encryption and integrity protection of data;
Selection of an AMF at UE attachment when no routing to an AMF can be determined from the information provided by the UE;
Routing of User Plane data towards UPF(s);
Routing of Control Plane information towards AMF;
Connection setup and release;
Scheduling and transmission of paging messages;
Scheduling and transmission of system broadcast information (originated from the AMF or OAM);
Measurement and measurement reporting configuration for mobility and scheduling;
Transport level packet marking in the uplink;
Session Management;
Support of Network Slicing;
QoS Flow management and mapping to data radio bearers;
Support of UEs in RRC_INACTIVE state;
Distribution function for NAS messages;
Radio access network sharing;
Dual Connectivity;
Tight interworking between NR and E-UTRA.

The Access and Mobility Management Function (AMF) hosts the following main functions:
Non-Access Stratum, NAS, signaling termination;
NAS signaling security;
Access Stratum, AS, Security control;
Inter Core Network, CN, node signaling for mobility between 3GPP access networks;
Idle mode UE Reachability (including control and execution of paging retransmission);
Registration Area management;
Support of intra-system and inter-system mobility;
Access Authentication;
Access Authorization including check of roaming rights;
Mobility management control (subscription and policies);
Support of Network Slicing;
Session Management Function, SMF, selection.

Furthermore, the User Plane Function, UPF, hosts the following main functions:
Anchor point for Intra-/Inter-RAT mobility (when applicable);
External PDU session point of interconnect to Data Network;
Packet routing & forwarding;
Packet inspection and User plane part of Policy rule enforcement;
Traffic usage reporting;
Uplink classifier to support routing traffic flows to a data network;
Branching point to support multi-homed PDU session;
QoS handling for user plane, e.g. packet filtering, gating, UL/DL rate enforcement;
Uplink Traffic verification (SDF to QoS flow mapping);
Downlink packet buffering and downlink data notification triggering.

Finally, the Session Management function, SMF, hosts the following main functions:
Session Management;
UE IP address allocation and management;
Selection and control of UP function;
Configures traffic steering at User Plane Function, UPF, to route traffic to proper destination;
Control part of policy enforcement and QoS;
Downlink Data Notification.

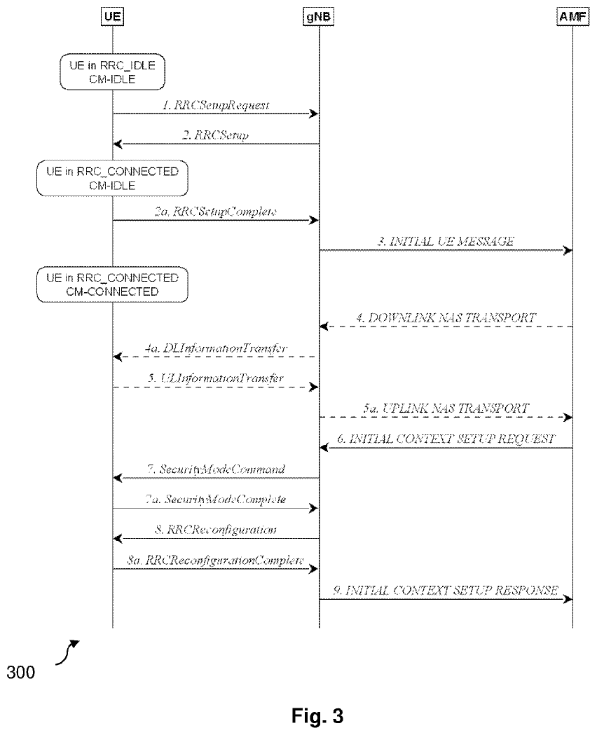

FIG. 3 illustrates some interactions between a UE, gNB, and AMF (an 5GC entity) in the context of a transition of the UE from RRC_IDLE to RRC_CONNECTED for the NAS part (see TS 38.300 v16.3.0). The transition steps are as follows:
1. The UE requests to setup a new connection from RRC_IDLE.
2/2a. The gNB completes the RRC setup procedure.
NOTE: The scenario where the gNB rejects the request is described below.
3. The first NAS message from the UE, piggybacked in RRCSetupComplete, is sent to AMF.
4/4a/5/5a. Additional NAS messages may be exchanged between UE and AMF, see TS 23.502.
6. The AMF prepares the UE context data (including PDU session context, the Security Key, UE Radio Capability and UE Security Capabilities, etc.) and sends it to the gNB.
7/7a. The gNB activates the AS security with the UE.
8/8a. The gNB performs the reconfiguration to setup SRB2 and DRBs.
9. The gNB informs the AMF that the setup procedure is completed.

RRC is a higher layer signaling (protocol) used for UE and gNB configuration. In particular, this transition involves that the AMF prepares the UE context data (including e.g. PDU session context, the Security Key, UE Radio Capability and UE Security Capabilities, etc.) and sends it to the gNB with the INITIAL CONTEXT SETUP REQUEST. Then, the gNB activates the AS security with the UE, which is performed by the gNB transmitting to the UE a SecurityModeCommand message and by the UE responding to the gNB with the SecurityModeComplete message. Afterwards, the gNB performs the reconfiguration to setup the Signaling Radio Bearer 2, SRB2, and Data Radio Bearer(s), DRB(s) by means of transmitting to the UE the RRCReconfiguration message and, in response, receiving by the gNB the RRCReconfigurationComplete from the UE. For a signaling-only connection, the steps relating to the RRCReconfiguration are skipped since SRB2 and DRBs are not setup. Finally, the gNB informs the AMF that the setup procedure is completed with the INITIAL CONTEXT SETUP RESPONSE.

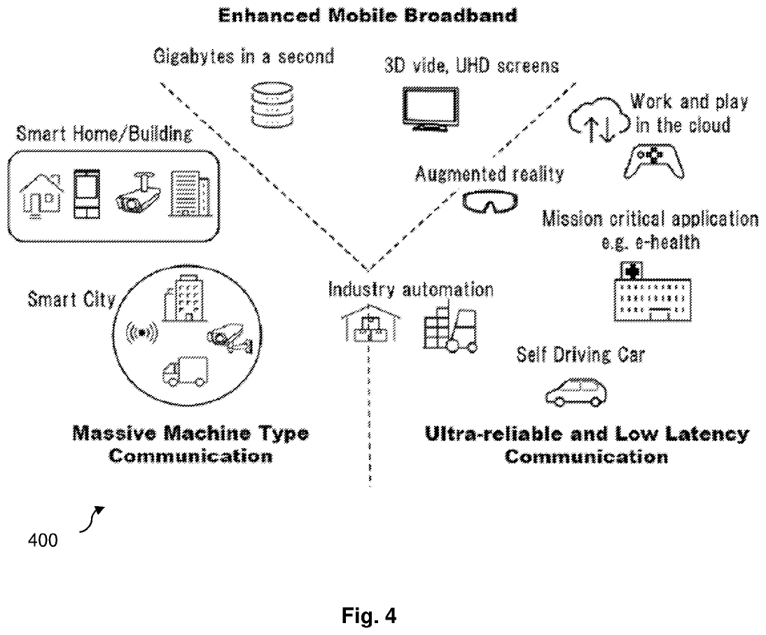

FIG. 4 illustrates some of the use cases for 5G NR. In 3rd generation partnership project new radio (3GPP NR), three use cases are being considered that have been envisaged to support a wide variety of services and applications by IMT-2020. The specification for the phase 1 of enhanced mobile-broadband (eMBB) has been concluded. In addition to further extending the eMBB support, the current and future work would involve the standardization for ultra-reliable and low-latency communications (URLLC) and massive machine-type communications. FIG. 4 illustrates some examples of envisioned usage scenarios for IMT for 2020 and beyond (see e.g. ITU-R M.2083 FIG. 2).

The URLLC use case has stringent requirements for capabilities such as throughput, latency and availability and has been envisioned as one of the enablers for future vertical applications such as wireless control of industrial manufacturing or production processes, remote medical surgery, distribution automation in a smart grid, transportation safety, etc. Ultra-reliability for URLLC is to be supported by identifying the techniques to meet the requirements set by TR 38.913. For NR URLLC in Release 15, key requirements include a target user plane latency of 0.5 ms for UL (uplink) and 0.5 ms for DL (downlink). The general URLLC requirement for one transmission of a packet is a BLER (block error rate) of 1E-5 for a packet size of 32 bytes with a user plane latency of 1 ms.

From the physical layer perspective, reliability can be improved in a number of possible ways. The current scope for improving the reliability involves defining separate CQI tables for URLLC, more compact DCI formats, repetition of PDCCH, etc. However, the scope may widen for achieving ultra-reliability as the NR becomes more stable and developed (for NR URLLC key requirements). Particular use cases of NR URLLC in Rel. 15 include Augmented Reality/Virtual Reality (AR/VR), e-health, e-safety, and mission-critical applications.

Moreover, technology enhancements targeted by NR URLLC aim at latency improvement and reliability improvement. Technology enhancements for latency improvement include configurable numerology, non slot-based scheduling with flexible mapping, grant free (configured grant) uplink, slot-level repetition for data channels, and downlink pre-emption. Pre-emption means that a transmission for which resources have already been allocated is stopped, and the already allocated resources are used for another transmission that has been requested later, but has lower latency/higher priority requirements. Accordingly, the already granted transmission is pre-empted by a later transmission. Pre-emption is applicable independent of the particular service type. For example, a transmission for a service-type A (URLLC) may be pre-empted by a transmission for a service type B (such as eMBB). Technology enhancements with respect to reliability improvement include dedicated CQI/MCS tables for the target BLER of 1E-5.

The use case of mMTC (massive machine type communication) is characterized by a very large number of connected devices typically transmitting a relatively low volume of non-delay sensitive data. Devices are required to be low cost and to have a very long battery life. From NR perspective, utilizing very narrow bandwidth parts is one possible solution to have power saving from UE perspective and enable long battery life.

As mentioned above, it is expected that the scope of reliability in NR becomes wider. One key requirement to all the cases, and especially necessary for URLLC and mMTC, is high reliability or ultra-reliability. Several mechanisms can be considered to improve the reliability from radio perspective and network perspective. In general, there are a few key potential areas that can help improve the reliability. Among these areas are compact control channel information, data/control channel repetition, and diversity with respect to frequency, time and/or the spatial domain. These areas are applicable to reliability in general, regardless of particular communication scenarios.

For NR URLLC, further use cases with tighter requirements have been identified such as factory automation, transport industry and electrical power distribution, including factory automation, transport industry, and electrical power distribution. The tighter requirements are higher reliability (up to 10⁻⁶ level), higher availability, packet sizes of up to 256 bytes, time synchronization down to the order of a few us where the value can be one or a few us depending on frequency range and short latency in the order of 0.5 to 1 ms in particular a target user plane latency of 0.5 ms, depending on the use cases.

Moreover, for NR URLLC, several technology enhancements from the physical layer perspective have been identified. Among these are PDCCH (Physical Downlink Control Channel) enhancements related to compact DCI, PDCCH repetition, increased PDCCH monitoring. Moreover, UCI (Uplink Control Information) enhancements are related to enhanced HARQ (Hybrid Automatic Repeat Request) and CSI feedback enhancements. Also PUSCH enhancements related to mini-slot level hopping and retransmission/repetition enhancements have been identified. The term “mini-slot” refers to a Transmission Time Interval (TTI) including a smaller number of symbols than a slot (a slot comprising fourteen symbols).

The 5G QoS (Quality of Service) model is based on QoS flows and supports both QoS flows that require guaranteed flow bit rate (GBR QoS flows) and QoS flows that do not require guaranteed flow bit rate (non-GBR QoS Flows). At NAS level, the QoS flow is thus the finest granularity of QoS differentiation in a PDU session. A QoS flow is identified within a PDU session by a QoS flow ID (QFI) carried in an encapsulation header over NG-U interface.

For each UE, 5GC establishes one or more PDU Sessions. For each UE, the NG-RAN establishes at least one Data Radio Bearers (DRB) together with the PDU Session, and additional DRB(s) for QoS flow(s) of that PDU session can be subsequently configured (it is up to NG-RAN when to do so), e.g. as shown above with reference to FIG. 3. The NG-RAN maps packets belonging to different PDU sessions to different DRBs. NAS level packet filters in the UE and in the 5GC associate UL and DL packets with QoS Flows, whereas AS-level mapping rules in the UE and in the NG-RAN associate UL and DL QoS Flows with DRBs.

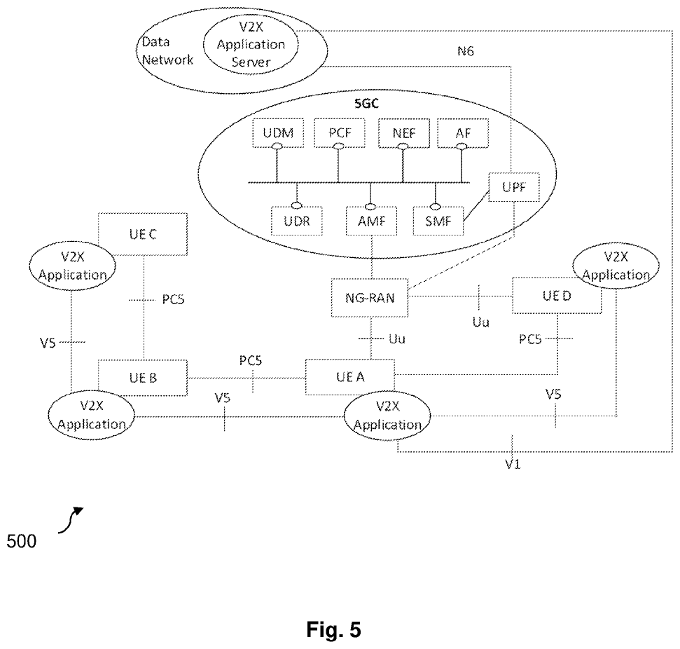

FIG. 5 illustrates a 5G NR non-roaming reference architecture (see TS 23.287 v16.4.0, section 4.2.1.1). An Application Function (AF), e.g. an external application server hosting 5G services, exemplarily described in FIG. 4, interacts with the 3GPP Core Network in order to provide services, for example to support application influence on traffic routing, accessing Network Exposure Function (NEF) or interacting with the Policy framework for policy control (see Policy Control Function, PCF), e.g. QoS control. Based on operator deployment, Application Functions considered to be trusted by the operator can be allowed to interact directly with relevant Network Functions. Application Functions not allowed by the operator to access directly the Network Functions use the external exposure framework via the NEF to interact with relevant Network Functions.

FIG. 5 shows further functional units of the 5G architecture for V2X communication, namely, Unified Data Management (UDM), Policy Control Function (PCF), Network Exposure Function (NEF), Application Function (AF), Unified Data Repository (UDR), Access and Mobility Management Function (AMF), Session Management Function (SMF), and User Plane Function (UPF) in the 5GC, as well as with V2X Application Server (V2AS) and Data Network (DN), e.g. operator services, Internet access or 3rd party services. All of or a part of the core network functions and the application services may be deployed and running on cloud computing environments.

According to European Telecommunication Standards Institute (ETSI) technical report (TR) 103 300, the abstracted flow from V2X use cases for vulnerable road users (VRUs) includes:
1. Detection of the VRU presence. The alternatives are:
   VRU self-positioning, where the VRU has sensors and potentially other sources allowing it to determine its own properties, including its location and velocity;
   another road user (e.g. a V-ITS-S) detects and tracks the VRU; and
   roadside equipment connected to an R-ITS-S or a central ITS-S detects and tracks the VRU.
2. Evaluation whether the VRU is at potential risk from other road users and VRU position and dynamic state should be transmitted. Any party may transmit information about VRUs that it is aware of. Information on VRUs should be filtered and only be transmitted according to the message triggering conditions. The potential risk from other road users depends on the following conditions, among others:
   road layout;
   dynamic state of the VRU and the other road users; and
   traffic signal status for both VRU and vehicles, if relevant, and compliance to traffic lights.
3. Evaluation of safety message environment, specifically whether the VRU is part of a cluster, to determine whether the VRU's own ITS-S should transmit.
4. Transmission of information about VRU at-risk. Alternatives are as follows:
   VRU sends ego-status information;
   VRU cluster leader sends cluster information; and
   V-ITS-S, R-ITS-S, C-ITS-S or another road user sends information about a VRU in a potential risk situation.
5. Risk assessment. Phases (receiver side) include:
   fusion of sensor data, and observed information transmitted by other road users to build a local dynamic map, with information about road users' location, velocity and potentially other data, e.g. intention; and
   assessment of risk based on estimated trajectory and velocity of different road users.
6. Warning or action to protect the VRU, including:
   warning of the device carrier (VRU or any other road user); transmission of collision warning to other road users; and
   action in the case of an automated vehicle.

As mentioned earlier, for the safety concern of VRUs, the most fundamental step is the Detection of the VRU presence. It is not clear when a VRU-UE should transmit its SL broadcast signal and security message to indicate its presence. It is further noted that, in LTE and NR uplink and downlink (Uu), DRX is used for power saving purpose. A VRU-UE only needs to wake up DRX on-duration to monitor possible PDCCHs and perform potential transmission. On this basis, a UE with SL capability should utilize DRX features as much as possible to reduce wake-up times for power saving purposes.

In various embodiments below, the following type of road users are considered as vulnerable road users (VRU) according to ETSI TR 103 300 and also the classification in Annex 1 of Regulation (EU) 168/2013 [i.8]:
Pedestrians (including children, elderly, joggers).
Emergency responders, safety workers, road workers.
Animals such as horses, dogs down to relevant wild animals (see note below).
Wheelchairs users, prams.
Skaters, Skateboards, Segway, potentially equipped with an electric engine.
Bikes and e-bikes with speed limited to 25 km/h (e-bikes, class L1e-A [i.8]).
High speed e-bikes speed higher than 25 km/h, class L1e-B [i.8].
Powered Two Wheelers (PTW), mopeds (scooters), class L1e [i.8].
PTW, motorcycles, class L3e [i.8];
PTW, tricycles, class L2e, L4e and L5e [i.8] limited to 45 km/h;
PTW, quadricycles, class L5e and L6e [i.8] limited to 45 km/h.
NOTE: Relevant wild animals are only those which present a safety risk to other road users (VRUs, vehicles)

In various embodiments below, a communication apparatus may refer to a sidelink UE. The sidelink UE may transmit and/or receive sidelink signals such as Physical Sidelink Control Channels (PSCCHs), Physical Sidelink Shared Channels (PSSCHs), Sidelink Synchronization Blocks (S-SSBs), Physical Sidelink Feedback Channels (PSFCHs), first-stage and second-stage Sidelink Control Information (SCI), Downlink Control Indication signal, Radio Resource Control signal, Media Access Control (MAC) Control Element (CE), Radio Resource Control (RRC) signal, Physical Downlink Control Channels (PDCCHs), Sidelink Synchronization Signals (SLSSs), Physical Sidelink Broadcast Channel (PSBCHs), and Physical Sidelink Feedback Channels (PSFCHs).

According to the present disclosure, a communication apparatus may be configured to operate or determine to operate in a power saving state. The power saving state may be one of a plurality of power saving states operable by the communication apparatus. Each of the one of the plurality of power saving states corresponds to different features/capabilities featuring a different level of power saving during operation.

In various embodiments, where a communication apparatus may refer to a sidelink (SL) user equipment (UE), another communication apparatus may communicate with the sidelink UE through transmitting and/or receiving sidelink signals, the other communication apparatus being one of (i) a base station (gNodeB or gNB) or a cellular network, where the sidelink UE is within a network coverage of the base station or the cellular network, and (ii) another sidelink UE regardless of whether or not both the sidelink UE and the other sidelink UE are within a network coverage of a base station.

In various embodiments, a default power saving state or an initial power saving state may be one of the plurality of power saving states that is (pre-)configured to be operated by a communication apparatus. Such default/initial power saving state can be either the most power-saving state, the most power-consuming state, or a preferred/suitable power saving state determined by the communication apparatus or by another communication apparatus (e.g. gNB, another SL UE) based on the current operating conditions and parameters, or any other state. Such default power saving state can also be (pre-)configured or (pre-)defined by either specifications (e.g. 3GPP specification), government regulators or UE vendors.

In various embodiments, the term “state” in power saving state can be used interchangeably with “mode”, “scheme”, “type” and “level”.

In various embodiments, parameters relating to a communication apparatus may refer to relevant factors considered and used for determining a power saving state to operate such a transmission/reception priority of the communication apparatus, a velocity in which the communication apparatus is moving, a communication apparatus type, a vehicle type (e.g. train, bus, van, sedan, bicycle), a Global Navigation Satellite System (GNSS) location of the communication apparatus 600, a congestion level of a network traffic and a road traffic around the communication apparatus 600, a zone identifier (ID) indicating a geographical zone in which the communication apparatus 600 is located

As mentioned above, it is not clear how a SL UE should become power saving or operating in a power saving state, and how a SL UE to balance its power saving with performance requirement, for example, to transmit or receive certain types of sidelink signals. Hence, there is a need to address one or more of the above challenges and develop new communication apparatuses and communication methods for operating in a power saving state.

According to the present disclosure, a plurality of power saving states are defined to a SL UE, and the SL UE is configured to determine and operate in one of the plurality of power saving states. Each of the plurality of power save states are associated with different features/capability, featuring a different level of power saving. A power saving state can be configured or changed by either one of RRC configuration parameters, MAC CE, new SCI field/format via PSCCH signalling, or new DCI field/format via PDCCH signalling.

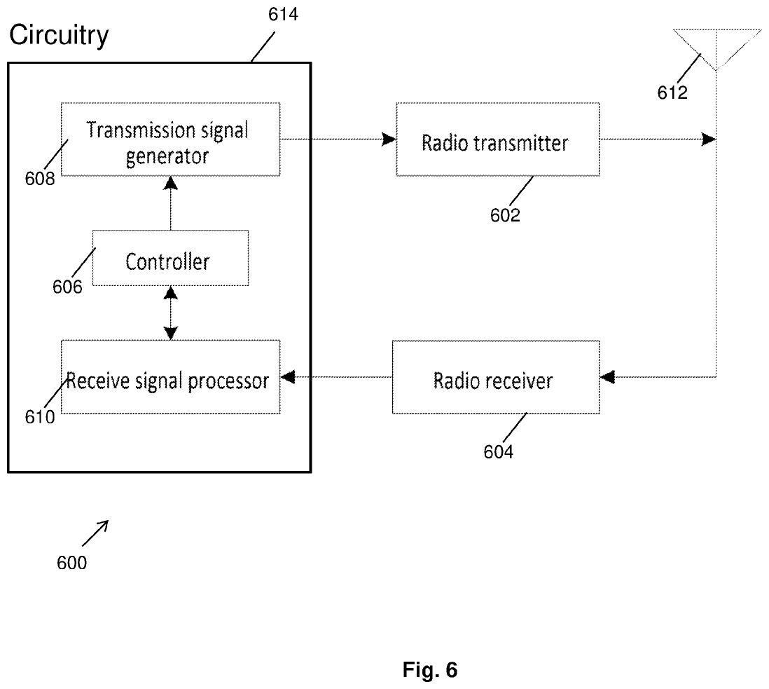

As shown in FIG. 6, the communication apparatus 600 may include circuitry 614, at least one radio transmitter 602, at least one radio receiver 604, and at least one antenna 612 (for the sake of simplicity, only one antenna is depicted in FIG. 6 for illustration purposes). The circuitry 614 may include at least one controller 606 for use in software and hardware aided execution of tasks that the at least one controller 606 is designed to perform, including control of communications with one or more other communication apparatuses in a wireless network. The circuitry 614 may furthermore include at least one transmission signal generator 608 and at least one receive signal processor 610. The at least one controller 606 may control the at least one transmission signal generator 608 for generating signals (for example, a sidelink/uplink/downlink signal) to be sent through the at least one radio transmitter 602 to one or more other communication apparatuses (e.g. peer communication apparatuses) and the at least one receive signal processor 610 for processing signals (for example, a sidelink/uplink/downlink signal) received through the at least one radio receiver 604 from the one or more other communication apparatuses under the control of the at least one controller 606. The at least one transmission signal generator 608 and the at least one receive signal processor 610 may be stand-alone modules of the communication apparatus 600 that communicate with the at least one controller 606 for the above-mentioned functions, as shown in FIG. 6. Alternatively, the at least one transmission signal generator 608 and the at least one receive signal processor 610 may be included in the at least one controller 606. In various embodiments, when in operation, the at least one radio transmitter 602, at least one radio receiver 604, and at least one antenna 612 may be controlled by the at least one controller 606.

The at least one transmitter 602 and the at least one receive receiver 604 may be included in a stand-alone module of the communication apparatus 600 to perform functions of both sending and receiving signals to and from another communication apparatus respectively. Such module may be referred to as a transceiver in various embodiments of the present disclosure.

It is appreciable to those skilled in the art that the arrangement of these functional modules is flexible and may vary depending on the practical needs and/or requirements. The data processing, storage and other relevant control apparatus can be provided on an appropriate circuit board and/or in chipsets.

The communication apparatus 600, when in operation, provides functions required for operating in a power saving state. For example, the communication apparatus 600 may be a sidelink UE or a VRU-UE. The circuitry 614 (the at least one controller 606 of the circuitry 614) may, in operation, determine one of a plurality of power saving states to operate in, and the transceiver (including the at least one radio transmitter 602 and the at least one radio receiver 604) may, in operation, transmit and/or receive at least one type of sidelink signals in response to determining the one of the plurality of power saving states. In an embodiment, the at least one transmission signal generator 608 and the at least one receive signal processor 610) may be respectively configured to transmit and receive the at least one type of sidelink signals such that the at least one radio transmitter 602 and the at least one radio receiver 604, or the transceiver (including the at least one radio transmitter 602 ad the at least one radio receiver 604) can transmit and/or receive the at least one type of sidelink signals when in operation.

In an embodiment, the transceiver may receive from another communication apparatus an indication signal relating to one of the plurality of power saving states, where the indication signal may include a request to operate in one of the plurality of power saving states, and the circuitry 614 (the at least one controller 606 of the circuitry 614) then determine to operate in the one of the plurality of power saving states in response to receiving the indication signal.

In another embodiment, when determining a power saving state to operate in, the circuitry 614 (the at least one controller 606 of the circuitry 614) may retrieve parameters relating to the communication apparatus 600, and the circuitry 614 (the at least one controller 606 of the circuitry 614) then determine to operate in one of the plurality of power saving states based on the retrieved parameters.

Yet in another embodiment, the transceiver may transmit assistance information comprising such parameters relating to the communication apparatus 600 to another communication apparatus prior to receiving from the other communication an indication signal relating to one of the plurality of power saving states from the other communication apparatus, for example, a power saving state that is suitable with balanced power saving and performance requirement determined based on the parameters, informing the communication apparatus to operate in that power saving state. The circuitry 614 (the at least one controller 606 of the circuitry 614) then determine to operate in the one of the plurality of power saving states in response to receiving the indication signal.

In another embodiment, the circuitry 614 of the communication apparatus 600 may identify one of the plurality of power saving states to operate in (or switch to), for example a preferred power saving state based on the parameters relating to the communication apparatus 600, and the transceiver may further transmit a request signal to another communication apparatus indicating a request to operate in (or switch to) the one of the plurality of power saving states. Subsequently, the transceiver may then receive a response signal from the other communication apparatus accepting the request and allowing the communication apparatus 600 to operate in that power saving state identified by the communication apparatus.

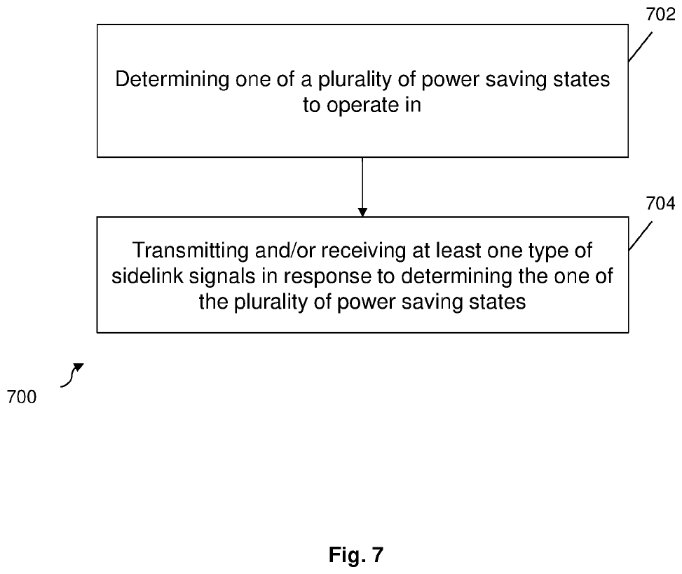

FIG. 7 shows a flow diagram illustrating a communication method 700 for operating in a power saving state in accordance with various embodiments of the present disclosure. In step 702, a step of determining a one of a plurality of power saving states. In step 704, a step of transmitting and/or receiving at least one type of sidelink signals in response to determining the one of the plurality of power saving states.

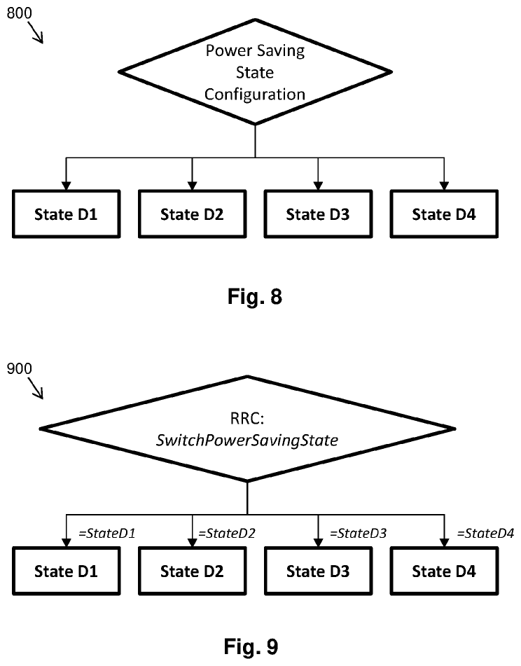

According to the present the disclosure, power saving states are (pre-)defined for a UE for different SL reception capabilities and thus respectively featuring different levels of power saving during operation. FIG. 8 depicts a flow diagram 800 illustrating four power saving state configurations (states D1-D4) for SL signals reception according to an embodiment of the present disclosure. The power saving states (states D1-D4) and their corresponding configurations may be (pre-)defined as follows:
State D1: UE supports reception of all types of SL signals and their features;
State D2: UE supports reception of PSCCH and PSSCH and their features only such as PSCCH sensing, PSSCH reception and decoding and no additional features like receiving SLSS/PSBCH when not required for power saving;
State D3: UE supports reception of PSCCH and its features only such as PSCCH reception for sensing only, no PSSCH reception is allowed when UE only performs sensing for resource selection; and
State D4: UE does not perform reception of any type of sidelink signals but transmission operation only.

A power saving state (e.g. one of states D1-D4) for a UE can be determined by the UE itself, a network or another SL UE for power saving purpose and/or system efficiency to ensure performance requirements. Additionally or alternatively, the power saving states for either SL reception or transmission can be additionally/separately defined to include/exclude other SL capabilities/features like full/partial sensing, reservation/pre-emption, monitoring/transmitting SLSS/PSBCH, PSFCH etc.

The power saving state could be configured/switched by using an indication signal for example as indication(s). Such indication signal may be one or a combination of the following:
RRC configuration from an upper layer, for example, either by UE itself or from the network. Such signaling may be realized by a new RRC parameter of SwitchPowerSavingState, and defined as a SEQUENCE for the state indexes or ENUMERATED for all the states;
MAC CE, for example, a new MAC CE with a new index to indicate a target power saving state;
First stage SCI via PSCCH signalling in a standalone PSCCH, or a PSCCH with a dummy PSSCH. Such PSCCH signalling may be realized by a field of one or several SCI bits (either specific or re-used) or a new SCI format to indicate the new power saving state to be changed;
Second stage SCI via PSSCH; and
PDCCH signalling if the UE is within gNB coverage (either mode-1 or mode-2). Such signalling may be realized by a field of DCI bits or new DCI format.

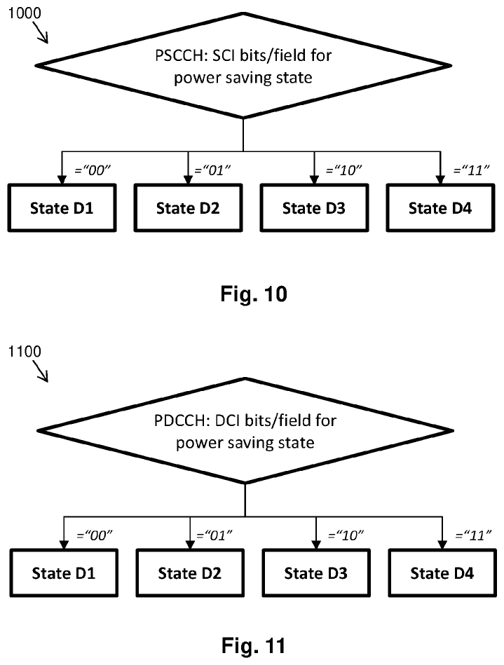

FIG. 9 depicts a flow chart 900 illustrating use of RRC configuration from an upper layer to configure a UE to operate in one of a plurality of power saving states for a UE according to an embodiment of the present disclosure. In this embodiment, a new RRC parameter of SwitchPowerSavingState is used, and four different values of the new RRC parameter indicate four power saving state configurations respectively (states D1-D4). For the sake of simplicity, only the new RRC parameter of SwitchPowerSavingState is demonstrated for the use of RRC configuration. It is appreciable that other RRC parameters may additionally or alternatively be used as indications to realize the power saving state configuration signalling.

FIG. 10 depicts a flow chart 1000 illustrating use of a PSCCH to configure a UE to operate in one of a plurality of power saving states according to another embodiment of the present disclosure. In this embodiment, PSCCH with two SCI bits of “00”, “01”, “10” and “11” are used to indicate four power saving state configurations (states D1, D2, D3 and D4) respectively.

Similarly, FIG. 11 depicts a flow chart 1100 illustrating use of a PDCCH to configure a UE to operate in one of a plurality of power saving states according to yet another embodiment of the present disclosure. In this embodiment, PDCCH with two DCI bits of “00”, “01”, “10” and “11” are used to indicate four power saving state configurations (states D1, D2, D3 and D4) respectively.

According to the present disclosure, a UE can switch to operate from one power saving state to another by event-triggering. Such triggering event may be from the UE itself, another UE, a gNB or a network. In one embodiment, UE upper layer determines a preference to switch its power saving state to another power saving state, for example, to reduce power consumption or to have better performance (with increased capabilities). Such preference to operate in the other power saving state may be determined based on parameters and relevant factors relating to the UE.

If the UE is under a network coverage, it informs the network about its preferred/desirable power saving state. If the network agrees, the network will inform the UE about the switching of power saving state; otherwise, no switching occurs. On the other hand, if the UE is not under the network coverage or the network does not control the switching of power saving state of the UE, the UE is then configured to switch to tis preferred/desirable power saving state.

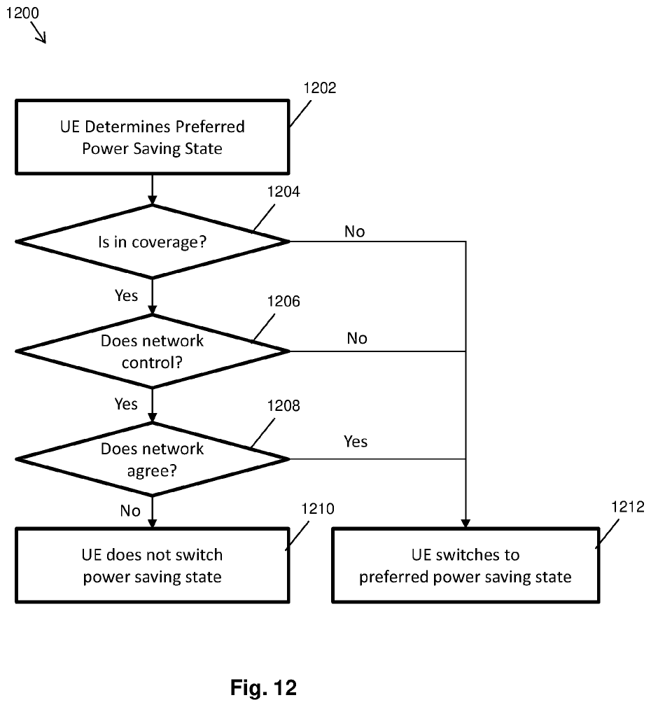

FIG. 12 depicts a flow chart 1200 illustrating a process to switch from a current power saving state to a UE's preferred power saving state according to an embodiment of the present disclosure. In step 1202, a UE is configured to determine a preferred power saving state. In step 1204, the UE determine if it is within a network (or gNB) coverage. If the UE is within the network coverage, step 1206 is carried out; otherwise step 1212 is carried out. In step 1206, the UE is configured to determine if the network controls the switching of power saving state of the UE. If the network controls the switching, step 1208 is carried out; otherwise step 1212 is carried out. In one embodiment, the UE is then further configured to send a request signal to indicate its preferred power saving state and a request to switch to the preferred power saving state to the network. In step 1208, the UE is configured to determine if the network agrees to switch to the UE's preferred power saving state, for example by determining if a response signal accepting the request is received by the UE. If the network does not agree, step 1210 is carried out where the UE does not switch to its preferred power saving state and remain its operation in the current power saving state; otherwise step 1212 is carried out. In step 1212, the UE is then configured to operate (or switch to) its preferred power saving state.

In addition to a request signal indicating a request to switch to a preferred power saving state of instead of the request signal, a UE may transmit assistance information comprising parameters (with relevant factors) relating to the UE to the network (or gNB).

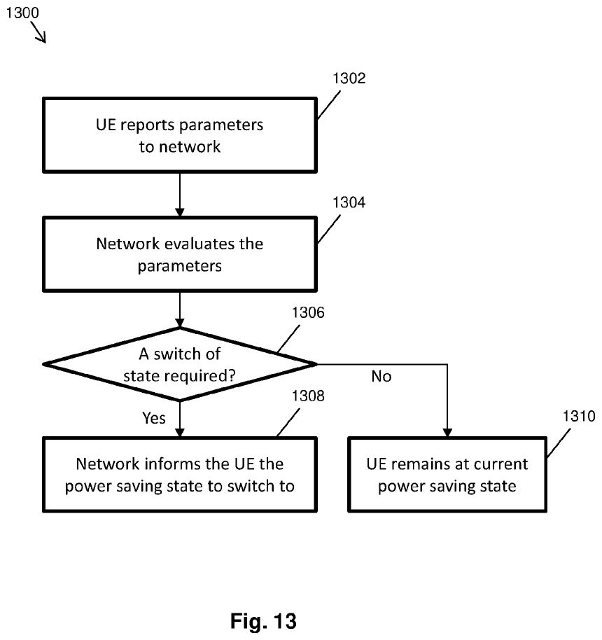

FIG. 13 depicts a flow chart 1300 illustrating a process to indicate a switch from a power saving state currently operated by a communication apparatus to another power saving state by another communication apparatus according to an embodiment of the present disclosure. For the sake of simplicity, a network is used to demonstrate the process. It is appreciable that any other communication apparatus such as gNB and another sidelink UE may be used in lieu of the network in the process to indicate an UE to switch from the current power saving state to the other power saving state.

In step 1302, the UE is configured to report its parameters and relevant factors to the network. In one embodiment, such parameters and relevant factors are included in UE assistance information transmitted to the network. In step 1304, the network is configured to evaluate the parameters and the relevant factors. In step 1306, the network is configured to determine if it is required for the UE to switch its power saving state. If it is determined by the network that a switch in the UE's power saving state is required, for example when it is determined by the network that a certain power saving state is more suitable for the UE to operate in (with balanced power saving and performance requirement) as compared to the current power saving state operated by the UE, step 1308 is carried out where the network is then configured to inform the UE to switch to the other power saving state, for example by sending to the UE an indication signal mentioned earlier to indicate the other power saving state; otherwise step 1310 is carried out. In step 1310, for example, it is determined that there is no need for the UE to switch, for example, there is no power saving state that is more suitable than the current power saving state, and the UE remains is operation under the current power saving state.

In various embodiments, a UE may be configured to determine to operate in (or switch to) a specific power saving state, or power saving state that supports or does not support certain features/functions. Similarly, an indication signal (for example RRC, PSCCH and PDCCH signals as shown in FIG. 10-12) or a response signal in response to a request by the UE may comprise indication(s) that informs the UE to operate in (or switch to) a specific power saving state directly, or a power saving state that a power saving states that supports or does not support certain features/functions.

For example, a UE may receive a signal to switch to a preferred power saving state D2, and if the UE is currently operating in power saving state D3, it would then switch to operate in power saving state D2. Alternatively, a UE may receive a signal to operate in a state that supports PSSCH, and therefore the UE may determine to operate in (or switch to) such power saving state. For example, if the UE is operating in state D3, upon receiving the signal, it would then switch to state D1 or D2. On the other hand, a UE may receive a signal to operate in a state that does not support PSSCH, and thus the UE may determine to operate in (or switch to) such power saving state. For example, if the UE is operating in state D1, upon receiving the signal, it would then switch to state D3 or D4.

As mentioned earlier, a SL UE could be (pre-)configured with a default/initial power saving state among a plurality of power saving states operable by the SL UE. When the SL UE is switched to a power saving state that is not its default/initial power saving state, a fallback timer, for example a timer-based fallback parameter, may be initiated and used to switch back to its default/initial power saving state once the fallback timer has expired. Such timer-based fallback parameter can be configured using one of a RRC signalling as a pattern/timer, or a MAC/PSCCH signalling similar to discontinuous reception (DRX).

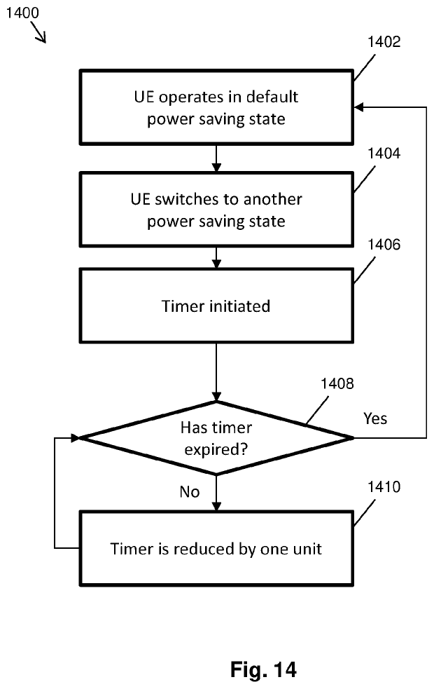

FIG. 14 depict a flow chart 1400 illustrating a process to operate in a default power saving state according to an embodiment of the present disclosure. In step 1402, a UE may be configured to operate in a default/initial power saving state. In step 1404, the UE may be further configured to determine another power saving state to operate in, and thus switch to that power saving state. In step 1406, a timer is initiated. In step 1408, it is determined if the timer has expired. If the timer has not expired, step 1410 is carried out where the timer is reduced by one unit. If the timer has expired, the UE is then configured to operate in its default power saving state.

Such default power saving state may be (pre-)configured or (pre-)defined by either specification (e.g. 3GPP), government regulators, or UE vendors. It is noted that the behaviours of different power saving states should be defined in 3GPP (RRC configuration, UE capabilities, etc.). The upper layer operation of which states to be implemented, and in what use case for a certain state to be implemented, should be up to country/region regulation or UE implementation and determination.

In an embodiment of the present disclosure, for a UE that supports reception of PSCCH and its features only such as PSCCH reception for sensing only, as shown in state D3 of FIG. 8, the UE only needs to be active when receiving the first stage SCI (e.g. the beginning 2 or 3 symbols in a SL slot) to monitor PSCCHs without 2nd stage SCI or PSSCH. In particular, the UE can be defined with only PSCCH sensing occasions and without PSSCH receiving slot/subframes. The UE could be in (micro/light/deep) sleep mode for the remaining of the symbols/slots of the PSCCH. Alternatively, the PSSCH receiving slots/subframes could be defined the same as the reception states which supports PSSCH receiving, the UE would monitor the PSCCH symbols within the PSSCH receiving slots/subframes.

Further, if another SL UE which intends to send a SL message carried by a PSSCH to the SL UE with PSCCH sensing only, the another SL UE may need to send a standalone PSCCH to inform the SL UE to switch to other power saving states capable for PSSCH receiving. The standalone PSCCH may carry one or several bits in SCI to inform to switch to a certain power saving state or a state supporting the function (e.g. PSSCH reception).

In the following paragraphs, certain exemplifying embodiments are explained with reference to terms related to 5G core network and the present disclosure regarding communication apparatuses and methods for sidelink broadcast, namely:

### Control Signals

In the present disclosure, the downlink control signal (information) related to the present disclosure may be a signal (information) transmitted through PDCCH of the physical layer or may be a signal (information) transmitted through a MAC Control Element (CE) of the higher layer or the RRC. The downlink control signal may be a pre-defined signal (information).

The uplink control signal (information) related to the present disclosure may be a signal (information) transmitted through PUCCH of the physical layer or may be a signal (information) transmitted through a MAC CE of the higher layer or the RRC. Further, the uplink control signal may be a pre-defined signal (information). The uplink control signal may be replaced with uplink control information (UCI), the 1st stage sidelink control information (SCI) or the 2nd stage SCI.

### Base Station

In the present disclosure, the base station may be a Transmission Reception Point (TRP), a clusterhead, an access point, a Remote Radio Head (RRH), an eNodeB (eNB), a gNodeB (gNB), a Base Station (BS), a Base Transceiver Station (BTS), a base unit or a gateway, for example. Further, in side link communication, a terminal may be adopted instead of a base station. The base station may be a relay apparatus that relays communication between a higher node and a terminal. The base station may be a roadside unit as well.

### Uplink/Downlink/Sidelink

The present disclosure may be applied to any of uplink, downlink and sidelink. The present disclosure may be applied to, for example, uplink channels, such as PUSCH, PUCCH, and PRACH, downlink channels, such as PDSCH, PDCCH, and PBCH, and side link channels, such as Physical Sidelink Shared Channel (PSSCH), Physical Sidelink Control Channel (PSCCH), and Physical Sidelink Broadcast Channel (PSBCH).

PDCCH, PDSCH, PUSCH, and PUCCH are examples of a downlink control channel, a downlink data channel, an uplink data channel, and an uplink control channel, respectively. PSCCH and PSSCH are examples of a sidelink control channel and a sidelink data channel, respectively. PBCH and PSBCH are examples of broadcast channels, respectively, and PRACH is an example of a random access channel.

### Data Channels/Control Channels

The present disclosure may be applied to any of data channels and control channels. The channels in the present disclosure may be replaced with data channels including PDSCH, PUSCH and PSSCH and/or control channels including PDCCH, PUCCH, PBCH, PSCCH, and PSBCH.

### Reference Signals

In the present disclosure, the reference signals are signals known to both a base station and a mobile station and each reference signal may be referred to as a Reference Signal (RS) or sometimes a pilot signal. The reference signal may be any of a DMRS, a Channel State Information-Reference Signal (CSI-RS), a Tracking Reference Signal (TRS), a Phase Tracking Reference Signal (PTRS), a Cell-specific Reference Signal (CRS), and a Sounding Reference Signal (SRS).

### Time Intervals

In the present disclosure, time resource units are not limited to one or a combination of slots and symbols, and may be time resource units, such as frames, superframes, subframes, slots, time slot subslots, minislots, or time resource units, such as symbols, Orthogonal Frequency Division Multiplexing (OFDM) symbols, Single Carrier-Frequency Division Multiplexing Access (SC-FDMA) symbols, or other time resource units. The number of symbols included in one slot is not limited to any number of symbols exemplified in the embodiment(s) described above, and may be other numbers of symbols.

### Frequency Bands

The present disclosure may be applied to any of a licensed band and an unlicensed band.

### Communication

The present disclosure may be applied to any of communication between a base station and a terminal (Uu-link communication), communication between a terminal and a terminal (Sidelink communication), and Vehicle to Everything (V2X) communication. The channels in the present disclosure may be replaced with PSCCH, PSSCH, Physical Sidelink Feedback Channel (PSFCH), PSBCH, PDCCH, PUCCH, PDSCH, PUSCH, and PBCH.

In addition, the present disclosure may be applied to any of a terrestrial network or a network other than a terrestrial network (NTN: Non-Terrestrial Network) using a satellite or a High Altitude Pseudo Satellite (HAPS). In addition, the present disclosure may be applied to a network having a large cell size, and a terrestrial network with a large delay compared with a symbol length or a slot length, such as an ultra-wideband transmission network.

### Antenna Ports

An antenna port refers to a logical antenna (antenna group) formed of one or more physical antenna(s). That is, the antenna port does not necessarily refer to one physical antenna and sometimes refers to an array antenna formed of multiple antennas or the like. For example, it is not defined how many physical antennas form the antenna port, and instead, the antenna port is defined as the minimum unit through which a terminal is allowed to transmit a reference signal. The antenna port may also be defined as the minimum unit for multiplication of a precoding vector weighting.

The present disclosure can be realized by software, hardware, or software in cooperation with hardware. Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration. However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing. If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus.

The communication apparatus may comprise a transceiver and processing/control circuitry. The transceiver may comprise and/or function as a receiver and a transmitter. The transceiver, as the transmitter and receiver, may include an RF (radio frequency) module including amplifiers, RF modulators/demodulators and the like, and one or more antennas.

Some non-limiting examples of such a communication apparatus include a phone (e.g, cellular (cell) phone, smart phone), a tablet, a personal computer (PC) (e.g, laptop, desktop, netbook), a camera (e.g, digital still/video camera), a digital player (digital audio/video player), a wearable device (e.g, wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g, an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

It will be appreciated by a person skilled in the art that numerous variations and/or modifications may be made to the present disclosure as shown in the specific embodiments without departing from the spirit or scope of the disclosure as broadly described. The present embodiments are, therefore, to be considered in all respects illustrative and not restrictive.

1. A communication apparatus comprising:
circuitry, which in operation, determines one of a plurality of power saving states to operate in; and
a transceiver, which in operation, transmit and/or receive at least one type of sidelink signals in response to determining the one of the plurality of power saving states.

2. The communication apparatus according to claim 1, wherein the circuitry is configured to determine the one of the plurality of power saving states to operate in based on an identification of a transmission and/or reception priority relating to the at least one type of sidelink signals.

3. The communication apparatus according to claim 1, wherein the one of the plurality of power saving states relates to one of: (a) reception of all types of sidelink signals, (b) reception of Physical Sidelink Control Channels (PSCCHs) and Physical Sidelink Shared Channels (PSSCHs) only, (c) reception of PSCCHs only, (d) reception of Sidelink Synchronization Blocks (S-SSBs) and/or a Physical Sidelink Feedback Channels (PSFCHs), (e) reception of PSCCHs and second-stage Sidelink Control Information (SCI) only.

4. The communication apparatus according to claim 3, wherein, when the one of the plurality of power saving states relates to reception of PSCCHs only, the communication apparatus is configured to be active when receiving a first stage SCI.

5. The communication apparatus according to claim 1, wherein the circuitry is configured to determine the one of the plurality of power saving states to operate in based on parameters relating to the communication apparatus.

6. The communication apparatus according to claim 5, wherein the parameters comprises at least one of a velocity, a communication apparatus type, a vehicle type, a Global Navigation Satellite System (GNSS) location, a congestion level, a zone ID of the communication apparatus.

7. The communication apparatus according to claim 5, wherein the transceiver further transmits assistance information comprising the parameters to another communication apparatus.

8. The communication apparatus according to claim 1, wherein the transceiver further transmits, to another communication apparatus, a request signal indicating a request to operate in one of the plurality of power saving states.

9. The communication apparatus according to claim 8, wherein the transceiver further receives a response signal accepting the request, and the circuitry is configured to determine the one of the plurality of power saving states to operate in based on the response signal.

10. The communication apparatus according to claim 1, wherein the transceiver receives, from another communication apparatus, an indication signal relating to one of the plurality of power saving states, and wherein the circuitry is configured to determine the one of the plurality of power saving states to operate in based on the indication signal.

11. The communication apparatus according to claim 10, wherein the indication signal relates to at least one of: Sidelink Control Indication (SCI) signaling, a Downlink Control Indication (DCI) signaling, a Media Access Control (MAC) Control Element (CE) signaling and a Radio Resource Control (RRC) signaling.

12. The communication apparatus according to claim 11, wherein the SCI signaling is carried by one of a first stage SCI of a standalone Physical Sidelink Control Channel (PSCCH), a PSCCH with a dummy Physical Sidelink Shared Channel (PSSCH) and a second stage SCI; and the DCI signaling is carried by a Physical Downlink Control Channel (PDCCH).

13. The communication apparatus according to claim 1, wherein the at least one type of sidelink signals comprising at least one of: a Physical Sidelink Control Channel (PSCCH), a Physical Sidelink Shared Channel (PSSCH), a Sidelink Synchronization Signal (SLSS), a Physical Sidelink Broadcast Channel (PSBCH), a Physical Sidelink Feedback Channel (PSFCH).

14. The communication apparatus according to claim 1, wherein the circuitry is further configured with a default power saving state and a fallback timer, the default power saving state being another one of the plurality of power saving states, the fallback timer being triggered upon operation in the one of the plurality of power saving states, and switch to the default power saving state from the one of the plurality of power states after the fallback timer has expired.

15. The communication apparatus according to claim 14, wherein the fallback timer is configured using one of: a RRC signaling, a MAC signaling and a PSCCH signaling.

16. A communication method comprising:
operating in one of a plurality of power saving states, each of the plurality of power states corresponding to a sidelink capability; and
transmitting and/or receiving at least one type of sidelink signals based on a sidelink capability corresponding to the one of the plurality of power saving states.
